(19) United States
(12) Patent Application Publication
(10) Pub. No.: US 2003/0055915 A1
(43) Pub. Date: Mar. 20, 2003

(54) Method and apparatus for transmitting data over a network

(76) Inventor: Kin Cuc Ngo, Pleasanton, CA (US)

Correspondence Address: PERKINS COIE LLP, P.O. BOX 2168, MENLO PARK, CA, 94026, US

(21) Appl. No.: 10/107,117

(22) Filed: Mar. 25, 2002

Related U.S. Application Data
(63) Continuation-in-part of application No. 10/035,140, filed on Dec. 19, 2001.
(60) Provisional application No. 60/322,595, filed on Sep. 14, 2001.

(51) Int. Cl. G06F 15/16; G06F 17/30; G06F 7/00

(52) U.S. Cl. 709/219; 709/203; 707/10

(57) ABSTRACT

A method of sending a file over a network from an originating node to a requesting client, comprising: receiving a request for the file at an intermediate node; providing a time insensitive component of the file to the client from the intermediate node; and providing a time sensitive component of the file to the client from the originating node.

### CROSS-REFERENCE TO RELATED APPLICATIONS

This application is a continuation-in-part (CIP) of and claims priority to Kgo's U.S. patent application Ser. No. 10/035,140, filed Dec. 19, 2001, and Kgo's provisional U.S. Patent Application No. 60/322,595, filed Sep. 14, 2001, both of which are incorporated herein by reference.

### BRIEF DESCRIPTION OF THE INVENTION

1. Field of the Invention

The present invention relates to network data transmission systems and more particularly to methods of file transmission over a network.

2. Background of the Invention

The Internet has expanded greatly since the beginning of the 1990's and Internet traffic continues to grow exponentially as more users and newer uses are being added to this worldwide system everyday. Simple text file transfers have been replaced by sophisticated web pages including music, graphics, animation and video clips. Increasing traffic on a network such as the Internet, along with larger file sizes has resulted in increasingly greater traffic congestion and longer access and download times.

Prior art FIG. 1 illustrates a traditional Internet web system. Referring to FIG. 1, a series of users “user1” 12 to “user N” 14 are connecting to the Internet through Internet Service Providers (ISP). A typical private user such as “user1” may connect to the Internet through the IPS servers 16 or 20. Business users may connect to the Internet through their intranet network and may pass through firewalls and/or proxy servers. Alternatively, users belonging to proprietary ISPs such as America Online or Prodigy may direct requests from their subscribers through a gateway and possibly a proxy server connecting their intranet to the Internet. In each case a user makes a request 13 for a web page. The request 13 travels through various intermediate servers/routers 24 and 28, and various links (e.g. satellite links) such as shown by 32 and 36 before reaching its final destination. Normally, the final destination is the web server 40 or alternatively a web server farm hosting the requested web page, where the web server or web server farm respond to the user's request by sending the requested web page and/or the corresponding information to the user.

The Internet is primarily based on a packet switching technique. In packet switching technique, a large file is parsed into smaller size packets. Each packet includes a header containing information such as the destination of the packet, its source and an identification number. Each packet may be transmitted via a different route, independent of the others. Once the all the packets arrive at the destination, they are reassembled based on the ordering information within the header.

The response 42 of the web server 40 will be routed via different routes based on the level of congestion in the system and the value of parameters of various routes. Newer routers using the Open Shortest Path First (OSPF) protocol are able to check a variety of parameters such as the number of hops, delay, capacity, throughput, and reliability of the circuit connecting the routers, in order to select the route by which to send the data. The response from the web server 40 may have to be channeled through the Internet via multiple servers/routers 26 and 30, and possible links 34 and 38 to the ISP servers 18 and 22 for each user 12 and 14.

In some cases, when private networks are connected to the Internet through a proxy server, the proxy server 18 or 22 may at least temporarily cache the most requested web pages in order to avoid using the Internet to get these web pages from the web server 40.

Prior art FIG. 2 is flow diagram for the processes of transmitting a file over the Internet. At block 44, a user (client) may transmit a request for data, through an ISP or other intermediate server to a web server. The prior art web server receiving the user request processes the data demand by packetizing and transmitting the requested data through the Internet to the requesting client. Most data transfers occurring over the Internet are based on a TCP/IP protocol. The web server on which the data resides would be process the request by packetizing the data and transmitting the packets via various routes to the requesting clients. At block 46, the client machine would receive packetized data corresponding to the requested data. At block 48, the client machine performs a sequence check to see that the packets are received in sequential order. In block 50, if the packets are in sequential order, the receiving machine transmits an acknowledgment for each packet received. In block 49, if packets are out of sequence, they are discarded and no acknowledgment is transmitted for any packets beginning with the first out of sequence packet. After a set period of time, not having received any acknowledgment form the receiving server, the web server transmitting the requested data would start retransmission of the series of packets starting with the first packets for which no acknowledgment was received. In block 51, the client machine checks for more data packet transmissions. If more data is to be received, the process of blocks 46-51 is repeated. In block 52, if no more data is to be received, the client machine reassembles the packets to reconstruct the data requested.

Prior art FIG. 3 is a representation of a packet under a TCP/IP protocol. Data 58 transmitted over the Internet is encapsulated according to the IP protocol prior to transmission. Headers and trailers are added to each data packet giving information about the content of the packet. The encapsulation of the data 58 in a header and trailers forms a frame and is similar to placing a letter in an envelop before mailing. However, in the case of a frame, the packet 58 is encapsulated with information necessary for routing the packet such as the origination IP address and destination IP address. Furthermore, additional data is included in the header or tail concerning various parameters such as the packet length, checksum for verifying errors occurring during transmission, and the order of the packets necessary for reassembly once the packets arrive at their destination.

Referring back to FIG. 3, a header 54 is added to the data packet providing the information necessary based on the network layer Internet Protocol (IP) layer. Similarly, the Transport layer protocol TCP requires the addition of a header and/or tail to the packet prior to transmission. The IP layer only handles the routing of the packets 58 but it does not guarantee any the delivery of the packet and simply discards any data packets if problems occur. The Transmission Control Protocol (TCP) provides a considerable number of services to the layers above the TCP layer. Most importantly, the TCP layer provides a connection-oriented and reliable protocol that enables an application to know that a packet sent over the Internet is received in its entirety at the destination. TCP receives messages from the destination acknowledging the receipt of a packet. Furthermore, the TCP communicates with the applications in the upper layers as well as the network systems below it such as the IP layer. In prior art FIG. 3, additional header and tail data 56 are added by the TCP layer to the packet, before transmission.

Prior Art FIG. 4 is a representation of web page level interactions between a client and server. The client computer 60 may be running a web browser 62 such as the Microsoft® Internet Explorer® or Netscape® Navigator®. Typically, a web browser 62 assembles and displays the data sent from the server 66 to the client 60 upon the request issued by the client computer 60. The client computer 60 connects to the desired server 66 using a Universal Resource Locator (URL) that acts as an address useful in locating the server 66. One of the most popular protocols used is the Hyper Text Transfer Protocol (HTTP) used on the World Wide Web (www). Other URL protocols such as the File Transfer Protocol (FTP) may be used to retrieve files over a network, such as the Internet. In the example of FIG. 4, using an HTTP URL, the client computer 60 sends a request to the server 66 for a Hyper Text Markup Language (HTML) file, namely a HTML web page 64. Once the web browser 62 starts receiving the packets for the file comprising the HTML web page 64, it starts assembling the web page and displays it on the client's computer monitor. Additional plug-in programs 65 may be operating with the web browser 62 to perform operations a basic web browser may not be able to perform.

The server 66 may be using a web server such as the Microsoft™ IIS web server 68 as its web server running on a Windows NT Server 68 operating system. The HTML file 64 the client has requested may include static HTML pages 72 as well as special programs such as animated graphics 74 or movies on the user's computer that would be downloaded to the client and run there using special plug-in programs 65.

One approach for the reducing the network congestion problems has been a brute force solution. Faster communications devices and better transmission mediums such as coaxial cable and optical lines have been used to increase the bandwidth and efficiency of the network systems. However, replacing existing cables and networking equipment with higher bandwidth and more efficient systems is costly. Furthermore, the rate of increase in network traffic is surpassing the rate at which such technological improvements are being introduced.

Another limitation of the standard network communication model is that each client requires its own bandwidth. Thus, the total required bandwidth is directly proportional to the number of users. Cache memory within some local servers such as proxy servers has been used to improve bandwidth limitations but using cache memory does not solve the problem because cache memory is also limited. Moreover, bandwidth limitations between the cache server and the client as well as the server capabilities introduce further limitations that affect the performance of the communication network.

Thus it is desirable to provide a system that is capable of improving network efficiency and freeing up available bandwidth, without expensive hardware improvements.

### SUMMARY OF THE INVENTION

Briefly, one aspect of the present invention is embodied in a method of operation for a system for transmitting and receiving data within a network comprising dividing a file into its dynamic data components and static data components by comparing at least one expiration parameter corresponding to each component to a set setting a threshold, transmitting a request for data from an intelligent client, receiving the data request by an intelligent server, transmitting at least the dynamic data components of the requested data to the intelligent client, and recreating by the intelligent client, the requested data by recombining the static components and the dynamic components of the requested data.

Another aspect of the present invention is embodied in a method of parsing data into its static and dynamic components, comprising setting a threshold value for separating static and dynamic data components, obtaining expiration parameters for each portion of data, comparing each expiration parameter to the threshold value, identifying as dynamic portions of the data that have an expiration value lower than the threshold value, and identifying as static portions of the data that have an expiration value higher than the threshold.

Another aspect of the present invention is embodied in a method of sending requested data to a client from an intelligent file server, comprising receiving a request for data from a client, data including static data components and dynamic data components, determining whether a client is intelligent, creating static data packets containing static data components and separate dynamic data packets containing dynamic data components, and transmitting static data components and dynamic data to the intelligent client.

Another aspect of the present invention is embodied in a method for processing data received from an intelligent server comprising, sending a request for data from an intelligent client, over a network, to an intelligent server, receiving static data packets and dynamic data packets separately, reconstructing the requested data from its static data packets and its dynamic data packets.

Another aspect of the present invention is embodied in a method of creating an intelligent protocol data packet comprising, including identifying information identifying the intelligent data protocol.

Another aspect of the present invention is embodied in a method for transmitting data over a network comprising, requesting data from a server connected to a network by a client connected to a network via a network connection provider system, capturing the data request by the server providing the network connection, checking a memory cache related to the network connection provider for the presence of a first saved data relating to the requested data, sending static data saved on the cache memory, sending a request to the server for all data not saved on the cache memory, transmitting all data not saved on the cache memory to the network connection provider, transmitting all data not saved on the cache memory to the client, and reconstructing the requested data from static data and dynamic data.

### BRIEF DESCRIPTION OF THE DRAWINGS

Prior art FIG. 1 illustrates a traditional web Internet system;

Prior art FIG. 2 is a flow diagram for the processes of transmitting a file over the Internet;

Prior art FIG. 3 is a representation of a packet under a TCP/IP protocol;

Prior Art FIG. 4 is a representation of web page level interactions between a client and a server;

FIG. 5 is an illustration of a data transmission system according to one embodiment of the present invention;

FIG. 6 is a flow diagram of the operation of one embodiment of the new data transmission system;

FIG. 7 is an intelligent server according to one embodiment of the present. invention;

FIG. 8 is a flow chart for the operation of one embodiment of an intelligent server;

FIG. 9 is an illustration of one embodiment of an intelligent ISP server;

FIG. 10 is a flow diagram of the operation of one embodiment of an intelligent ISP server;

FIG. 11 is an illustration of one embodiment of an intelligent client;

FIG. 12 is a flow diagram of the operation of one embodiment of the intelligent client;

FIG. 13 illustrates the static and dynamic data content of a typical file;

FIG. 14 is a flow diagram for the process of dividing a data file into its dynamic and static components for one embodiment of the present invention;

FIG. 15 illustrates a data packet according to one embodiment of the present invention;

FIG. 16 is a flow diagram of the operation of a system based on one embodiment of the present invention; and

FIG. 17 depicts a simplified block diagram one embodiment of the present invention.

### DETAILED DESCRIPTION OF THE INVENTION

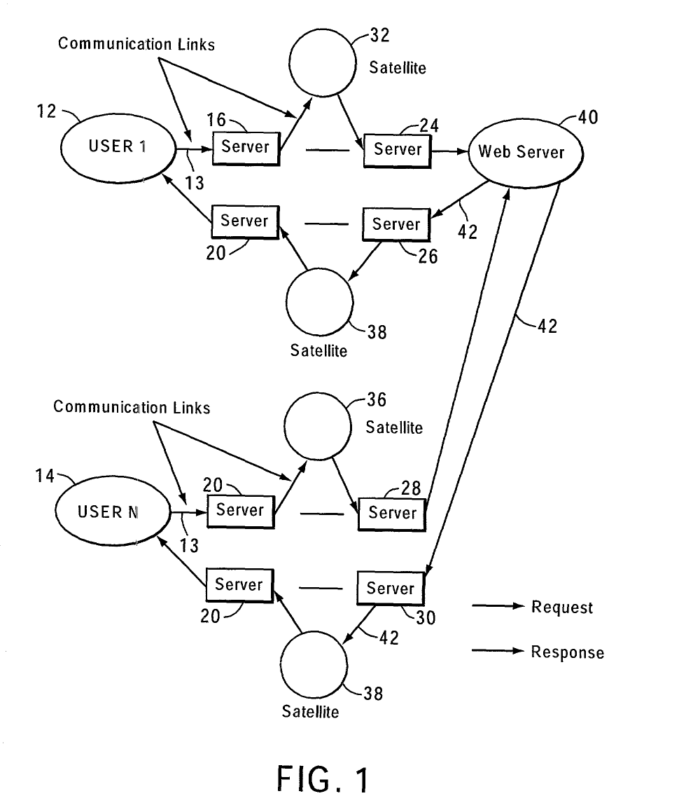

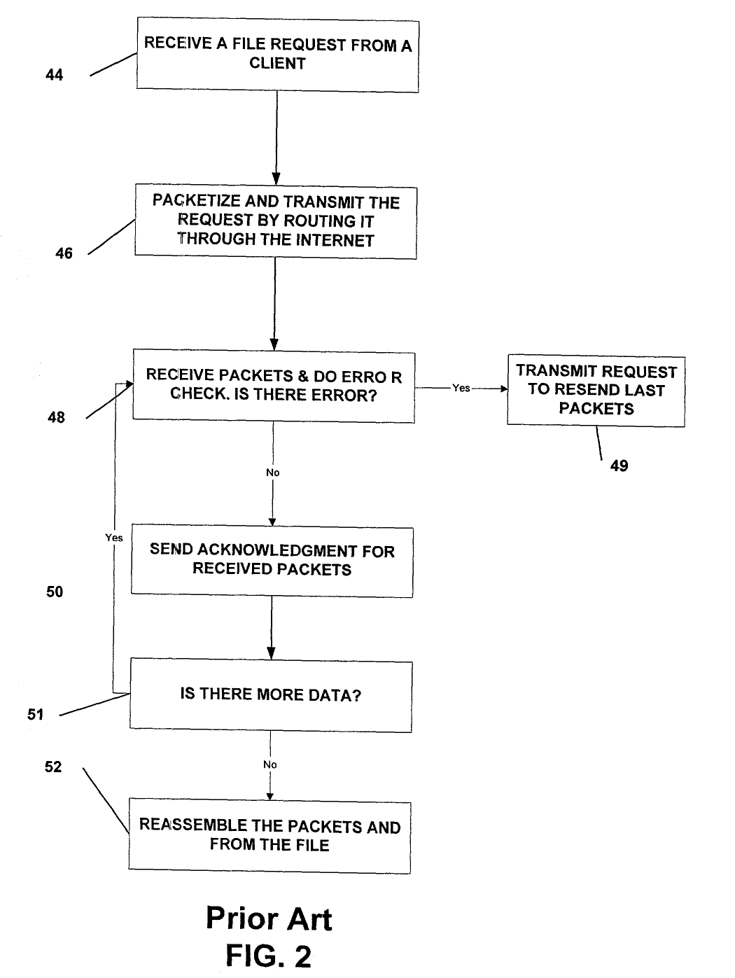

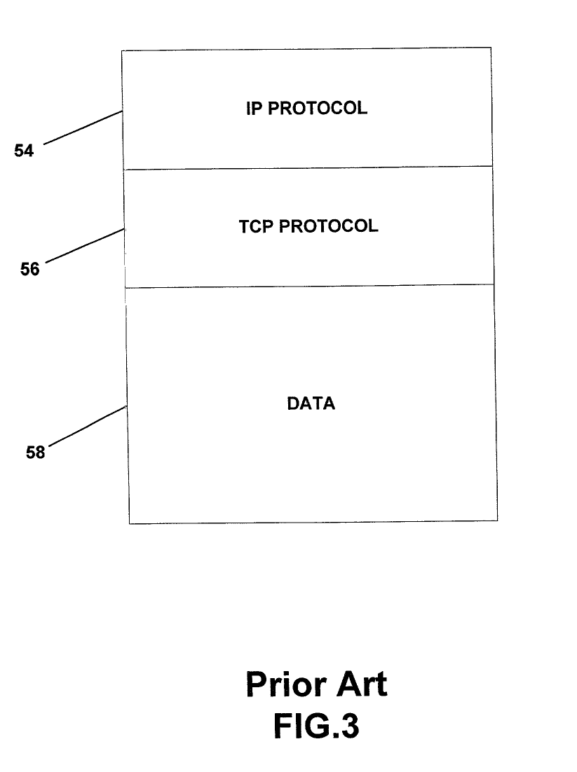

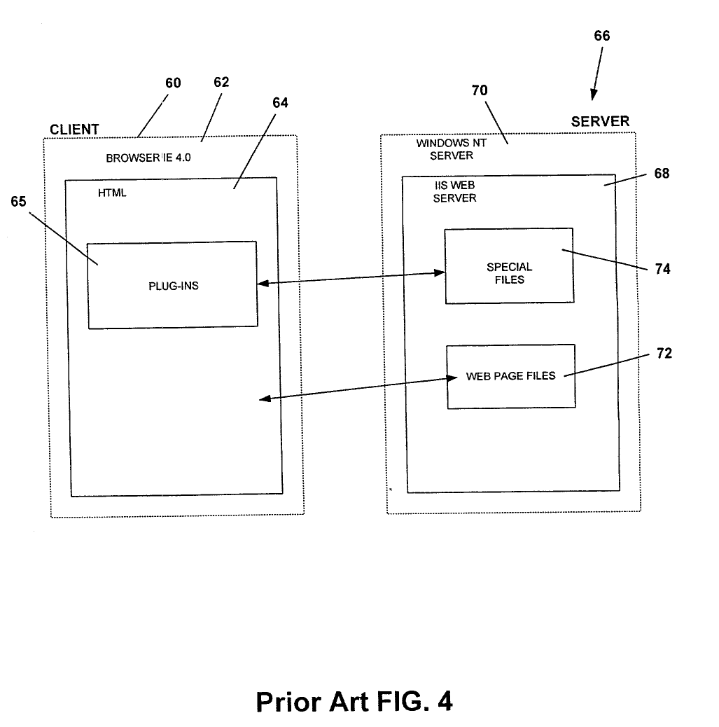

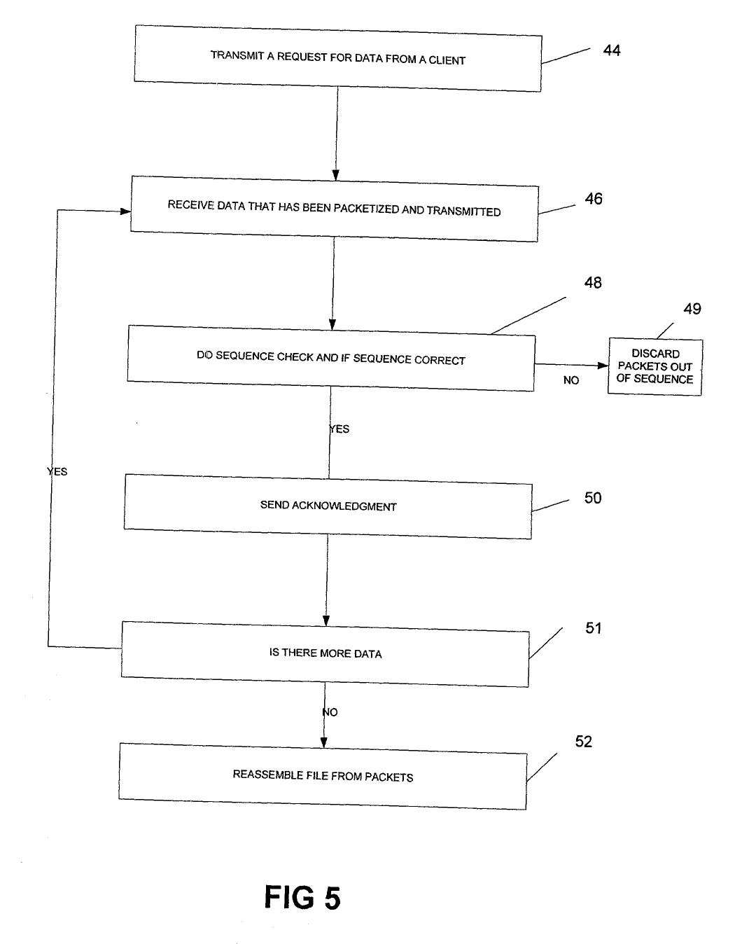

FIG. 5 is an illustration of a data transmission system 79 according to one embodiment the present invention. The data transmission system 79 includes, a legacy client A 80, an improved client B 78, an ISP server 82, a public network 84, a server 86, a gateway 94, a server 92, and an improved client 90. Client A 78 and client B 80 send requests for data through the Internet Service Provider server 82 and the network 84 to the server 86 that has the requested data 88. Client N 90 may be part of a private network 92. Client N 90 may use the private network 92 and the public network 84 to send its file requests to the server 86. The private network 92 may be connected to the public network 84 and protected from it by a firewall and/or proxy server 94.

Client A 78 may include a new technology enhanced browser also called an intelligent browser. The intelligent browser client A 78 is capable of receiving and processing packets that were parsed based on the new protocol. Client B 80 may have an old technology browser. Client B 80 would have to receive packets based on the old protocol in order to process and reassemble the packets it receives. The intelligent ISP server 82 may also be a new technology enhanced server also referred to as an intelligent ISP server, capable of receiving, processing and transmitting packets based on the new protocol. Additionally, the intelligent ISP server 82 may include cache memory 83 that might be used to store the static data portions of the most requested data files. In one embodiment of the present invention, when the intelligent ISP server 82 receives a request for data generated from client B 80, it hands down the request to an old technology ISP server that may be residing on the same physical machine or alternatively reside on a separate machine.

As used herein, the term “intelligent” machine, such as an intelligent server, or an intelligent ISP or an intelligent client refers to a machine that is capable of processing a data file that may be divided up into its dynamic and static data parts. As defined herein, “dynamic” content is data which is time sensitive &/or client specific. “Static” content is data that is neither time sensitive nor client specific, as describe further below. Processing may include parsing a data file into its components, transmitting, receiving, and reassembling the data file. In contrast, the term “non-intelligent” as used herein in this document refers to a client, file server or intermediate node server such as an ISP sever that is based on the current state of the art technology and does not parse data into its static and dynamic components.

The public network 84 may still operate based on the existing protocol. In one embodiment, the public network 84 may be the Internet and the governing protocol may be the TCP/IP protocol. However, it would be apparent to one skilled in the art that the teachings of the present invention are not limited to a particular protocol and/or a particular network type.

The intelligent server 86 may also be based on principles of tpi and thus capable of classifying, parsing and processing data files into their dynamic and static components. A file 88 residing on the server 86 may be divided into dynamic data and static data components by the server software based on some definition of dynamic and static data.

In one embodiment, the distinguishing characteristic between dynamic data and static data is based on the fact that dynamic data may be client specific or time dependent, whereas static data may be considered to be non-client specific data or relatively time independent. Static data content changes at such a slow rate that the server can treat it as static or constant. In contrast, dynamic data content changes so rapidly that the server must handle it as variable data.

It would be apparent to one skilled in the art that the definition of static and dynamic data is relative with respect to time sensitivity. A threshold may be set to separate dynamic data from static data. That is data with a rate of change greater than a set threshold may be treated as dynamic, whereas data with a rate of change below a certain rate may be treated as static data.

In the example of a web page file, the web designer may include in its design expiration dates for data comprising various parts of the web page. Things such as banners, logos, background and some text may have an expiration date set from days to months. On the other hand, if the web page includes a table of real time stock market values, the constantly changing stock values may have expiration dates of only several seconds. In this example, if the web server threshold is set at one minute, any data within the web page file that has an expiration date of greater than one minute may be classified as static data. At the same time, any data such as stock values with expiration dates of less than one minute will be treated as dynamic data.

In one embodiment, the threshold value of the server 86 may be adjusted based the level of service requested from the server. The lower the threshold value, a greater number of files would have an expiration date that is greater than the threshold value and as a result, the smaller the amount of dynamic data resulting in less work for the server.

Client C 90 and the ISP server 94 may also have intelligent browsers and be capable of receiving and processing packet packets based on the new protocol.

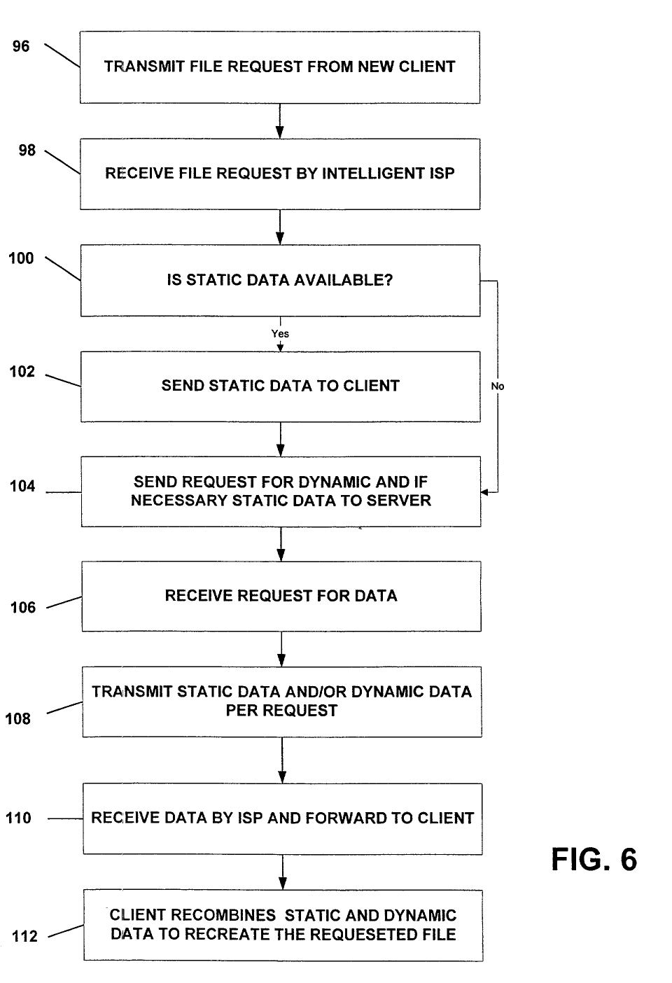

FIG. 6 is a flow diagram of the operation of one embodiment of the new data transmission system. At block 96, a data request is transmitted by an intelligent client (e.g. client A 78, FIG. 5) to an intelligent server (e.g. the intelligent server 86, FIG. 5). At block 98, the client: data request is received by an ISP sever. If the ISP server is an intelligent server (e.g. the ISP server 82, FIG. 5), the ISP server may process the request. In one embodiment, at block 100, the intelligent ISP server 82 checks the cache memory/server 83 (FIG. 5), to see if it is storing the static data components of the requested data. If the cache memory 83 does store the static data portion of the client requested data, the intelligent ISP server multicasts the static data, at block 102. At the same time, a request for the dynamic portion of the data is transmitted to the web server 86.

Alternatively, if the static data component of the requested data is not available at the cache memory 83, at block 104, the intelligent ISP server will request both the static and dynamic component of the client requested data from a corresponding web server.

In one embodiment, each memory/cache server is capable of handling a number of URLs. Each cache server in a groups of cache servers may service a particular group of servers located at a various URL addresses.

If the static data is unavailable on the memory/cache server, a request will be generated and sent to the web server that stores the requested data. As discussed before, once a memory/cache server has received a first request for a particular static data, it will obtain that data and have it available for multicast over its corresponding network. Intermediary routers, triggered by the client request connect a particular client requesting data to a particular memory/cache server that stores the data.

In an alternative embodiment, the static data components residing on a particular memory/cache server are being updated and refreshed periodically, independent of incoming client requests. However, the stored static data component will not be routed or transmitted to the network until at least one client has requested the data from its corresponding ISP, and that ISP has forwarded the request to the memory/cache server. After the first request has been received, the memory/cache server would multicast its data on the network.

In an exemplary embodiment, at the intelligent file server 86 side (FIG. 5), one method of multicasting static data components may include a data-on-demand method of multicasting comprising the steps of: receiving a data file, specifying a time interval, parsing the data file into a plurality of data blocks based on the time interval such that each data block is displayable during the time interval, determining a required number of time slots to send the data file, allocating to each time slot at least a first of the plurality of data blocks and optionally one or more additional data blocks, such that the plurality of data blocks is available in sequential order to a client accessing the data file during any time slot, and sending the plurality of data blocks based on the allocating step.

In one embodiment, the parsing step includes the steps of: determining an estimated data block size, determining a cluster size of a memory, and parsing the data based on the estimated data block size and the cluster size. In another embodiment, the determining step further includes the step of assessing resource allocation and bandwidth availability.

At block 106, intelligent server 86 receives a request for data. As discussed above, the request may be for both static and dynamic components data or only for the dynamic portion of the data. At block 108, the server 86 transmits the static and/or dynamic data components of the requesting data to the requesting client. At block 110, once the intelligent ISP server 82 (FIG. 5) receives the requested data from the intelligent server 86, including static and dynamic data components, it begins multicasting the static portion of the data over the bandwidth serving its clients, making it available to subsequent clients requesting the same data. The intelligent ISP server 82 also forwards updated dynamic data to a requesting intelligent client 78. At block 112, the requesting intelligent client 78 assembles the static and dynamic data to recreate the file it requested.

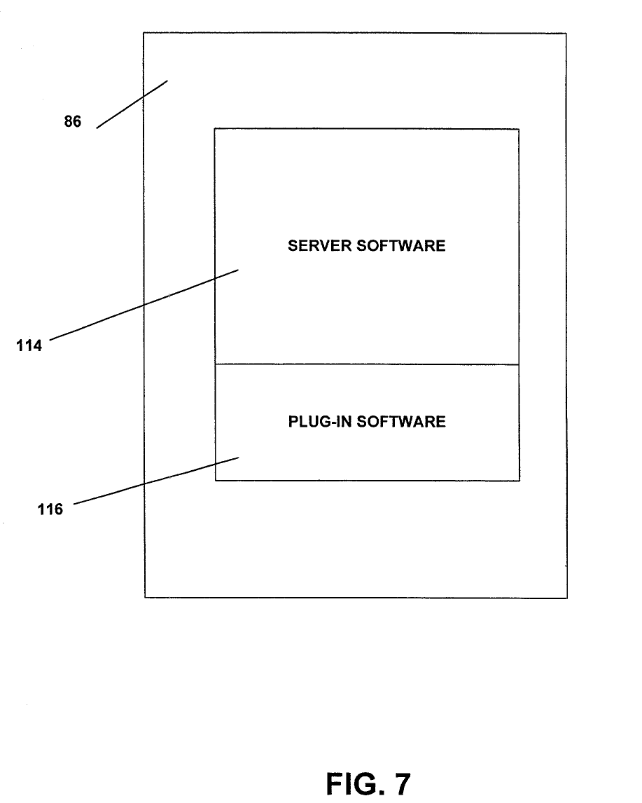

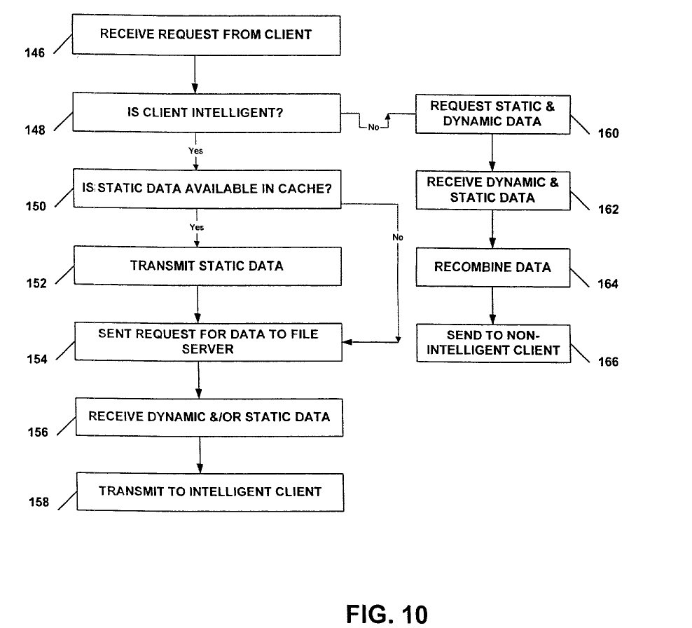

FIG. 7 is an intelligent server according to one embodiment of the present. invention. In one embodiment of the intelligent server 86, a server software 114 compliant with the existing protocol may comprise the basic operating software of the server. Add-on intelligent server software 116 may provide the additional capabilities necessary to classify static and dynamic data, parse a file into its static and dynamic components, packetize packets of appropriate size based on existing network protocols, while including header or trailer information allowing the identification of the new packets comprising the static and dynamic data. The format of a packet for use in the invention is described further in FIG. 10. In an alternative embodiment, the intelligent server software 116 may be residing on at least one physically separate machine and the server software 114 compliant with the existing protocol may be residing on a separate machine.

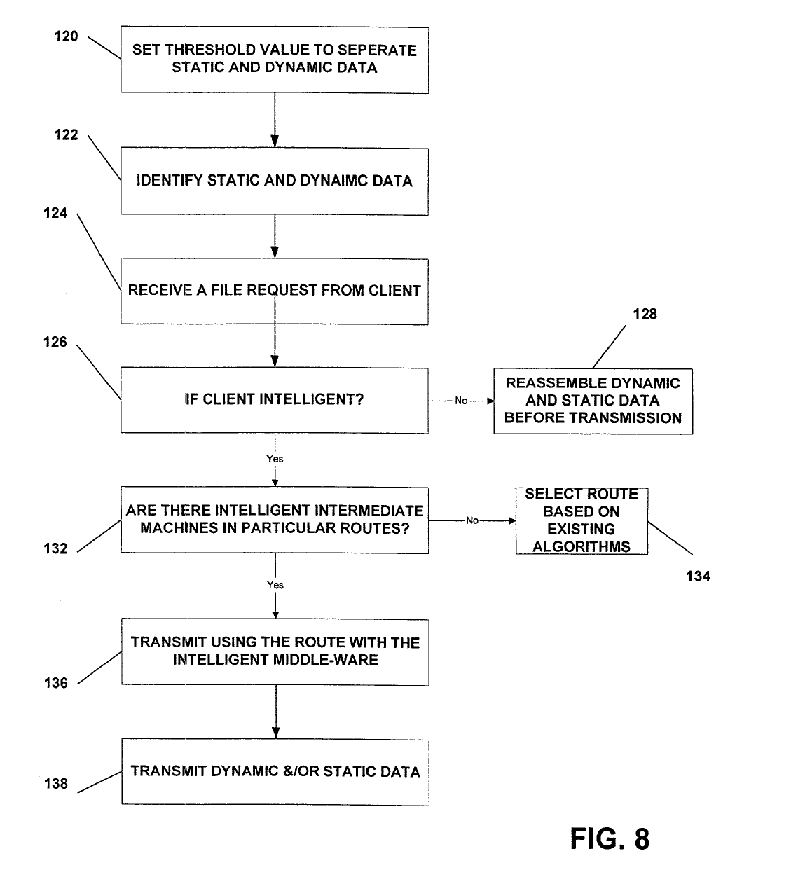

FIG. 8 is a flow chart for the operation of one embodiment of an intelligent server. At block 120, the intelligent server 86 may set a threshold value based upon which the dynamic and static data classification may be made.

The term intelligent server as used herein may refer to at least one of a data, file or web server capable of parsing a data file into its static and dynamic components, by setting a threshold value, and comparing each data file component's expiration parameter value to the threshold value, and separating the file into its static and dynamic data based on whether a file component expiration parameter value that is greater than the threshold value or less.

In one embodiment, the threshold value may be adjusted based on the performance requirements of the intelligent server. A lower threshold value may be used to reduce the operating burden of the intelligent server 86 by redefining a larger portion of each file as being comprised of static data, requiring less frequent retransmissions.

At block 122, the intelligent server 86 parses the data residing in its database storage into their dynamic and static data components based on the set threshold value. In one embodiment, parsing of a given data may be preformed in real time as request for the given data is received. In an alternative embodiment, data residing on the intelligent server is parsed offline, prior to any request being received, and the separate data components are stored as such. At block 124, the intelligent server 86 receives a request from a client machine.

Once the intelligent server 86 has received a request, it may ascertain whether the request came from an intelligent client at block 126. In one embodiment, at block 128, if the request came from a traditional client, the intelligent server hands the request down to a traditional server, based on the existing protocol to service the traditional client. The term traditional as used herein refers to a server or client that is not intelligent and is based on the existing technology. In an alternative embodiment, the intelligent server 86 is able to recombine the dynamic and static portions process the request based on the old network protocol. It would be apparent to one skilled in the art, that the intelligent server and the traditional server may reside on separate machines or co-exist on a single machine. In one embodiment, the intelligent server 86 is an intelligent web server, the network is the Internet and the applicable protocol may be the TCP/IP protocol.

At block 130, if the requesting client is an intelligent device, the intelligent server transmits static data and dynamic data separately.

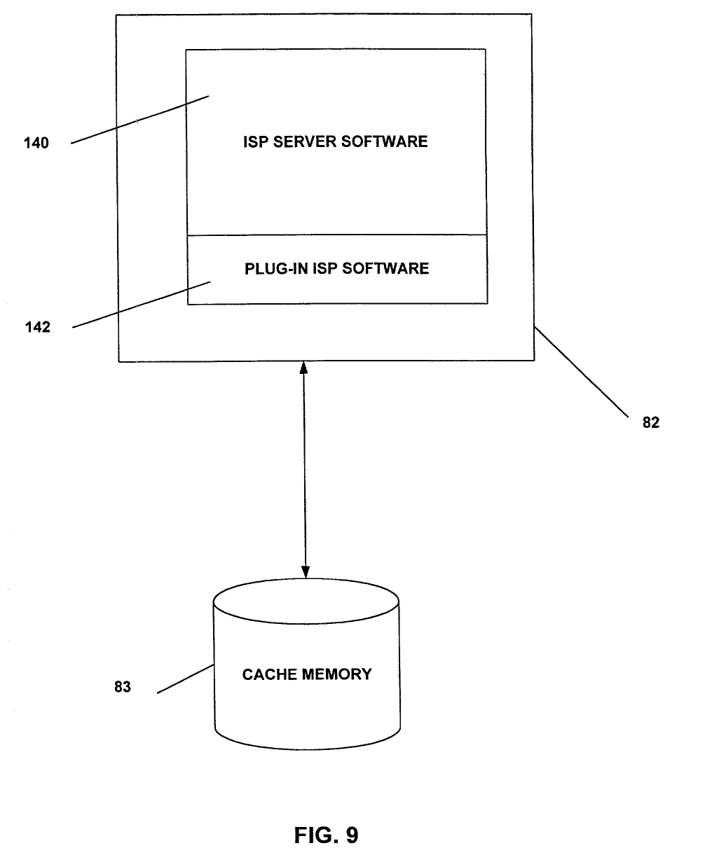

FIG. 9 is an illustration of one embodiment of an intelligent ISP server. In one embodiment the intelligent ISP server 82 (FIG. 5) includes an ISP operating software 140 that is fully compatible with the existing technology. Additionally, an add-on or plug-in software component 142 may be added to the ISP server 82 to allow it to receive, process and transmit the new protocol packets based on separate dynamic and static data components. Additionally, an intelligent ISP server 82 may include cache memory 83 (FIG. 5), that might be used to store the static data portions of the most requested data files.

The cache memory 83 may store at least part of the static data requested by a first client. This allows for multiple requests received for a particular data, web page or file to be at least partially fulfilled by the data present in the cache memory. In one embodiment, after the receiving a first request from an intelligent client, the intelligent ISP server starts multicasting the static data component of the requested data over its network coverage area. For example, if the data file requested by the client includes 100% static data, a request from any subsequent client for the same data file may be processed entirely by the local intelligent ISP server 82. After a first request, a copy of the static data components of the requested data from a first client request is cached, the ISP server will be able to supply the request and fulfill the response without the need to communicate back to the host web server. It would be apparent to one skilled in the art that the implementation of the teachings of the present invention would result in greatly reduced traffic over at least a part of the network is reduced. This scenario may also be implemented in cases of requests coming from traditional clients.

Alternatively, if the requested data contains both static and dynamic data components, the intelligent ISP server may send a request to the web server providing the data, requesting the dynamic data only, after having retrieved the static data component of the requested data following a first client data request. If the initial request came from an intelligent client, the intelligent data server may send the dynamic and the static components of the data separately. In one embodiment, after receiving a first request for a particular data, the intelligent ISP determines whether it has the static data component of the requested data in its local storage. If the static data is available at a local memory/cache server, the intelligent ISP server retrieves the static data and starts a multicast. Furthermore, the intelligent ISP server obtains the dynamic component of the requested data and forwards it to the requesting intelligent client.

Alternatively, if the static data is not stored on the ISP's local memory/storage server, both the dynamic and static data components are requested and received from the data server. The static data is multicast to the all the local users and the dynamic data is forwarded to each requesting intelligent client. In either scenario, the transferred data are smaller resulting in less traffic congestion on the Internet.

In one embodiment, if the requesting client is not an intelligent client, the intelligent ISP server may hand down the data request to an old protocol ISP server for servicing.

It would be apparent to one skilled in the art that the effect of the reductions in network traffic resulting from fewer requests and smaller size data file transmissions would multiply with the presence of increasing numbers of intelligent machines on the network.

The scenario described above may be replicated at each hop between a requesting intelligent client and an intelligent data server. The traffic between each node of each hop would be greatly reduced by applying the teaching of the present invention and the savings multiply with each hope. As a result, network traffic within the whole system would be greatly reduced.

FIG. 10 is a flow diagram of the operation of one embodiment of an intelligent ISP server. At block 146, the intelligent ISP server 82 (FIG. 5) receives a data request from a client. At block 148, the ISP server 82 determines if the request came from an intelligent client such as client 78 (FIG. 5) or an old technology client such as client 80 (FIG. 5). At block 150, if the request was initiated by an intelligent client 78, the ISP server checks its cache memory for the availability of the static data to be sent to the intelligent client. The term “Intelligent client” as used here refers to a client that is able to receive data files packets divided into static and dynamic data components and can recreate the complete data file by recombining both the static and dynamic data files. At block 150, if the static component of the requested data is stored in the local cache memory, the intelligent ISP server would multicast the static data over the network under its coverage. At block 154, the ISP server transmits a request for dynamic data to the intelligent file server 86. If the static data is not present in the local cache memory, the request transmitted at block 154 would include a request for the static data components as well. At block 156, the ISP server 82 receives the data that may include both static and dynamic data. At block 158, the ISP server 82 transmits the dynamic and static data to the requesting intelligent client 78.

In one embodiment, at block 160, if the request for data is received from an old technology client also referred to as non-intelligent client, the request is handed to a old technology server to process the file request according to the existing protocol. The term non-intelligent client or server refers to a machine that is operating based on the old technology and protocol and is unable to process separated static and dynamic components.

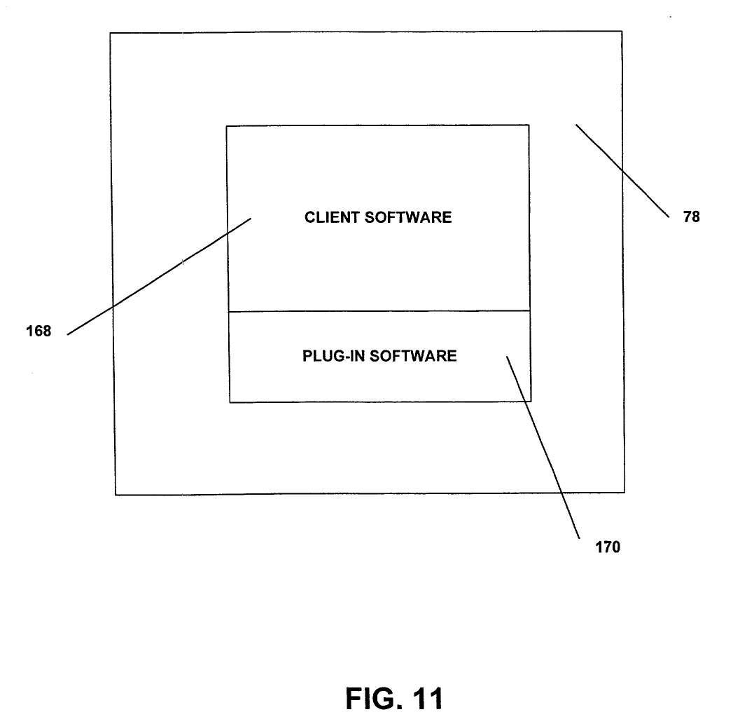

FIG. 11 is an illustration of one embodiment of an intelligent client 78 (FIG. 5). In one embodiment, the intelligent client 78 may include client-operating software 168 based on the existing (old) network protocol, and allowing the client to access the network using this software. In one embodiment, the client-operating software may a web browser allowing the client to access the Internet.

The intelligent client 78 may include an add-on or plug-in type of software 170 that enables the intelligent client to receive, detect, process and use the new protocol based on the dynamic and static data definitions. This implementation allows for backward compatibility of the intelligent client machine with the existing network and its operating protocol. Furthermore, the plug-in upgrade may allow the conversion of an old type client machine into an intelligent client machine by simply installing a software upgrade.

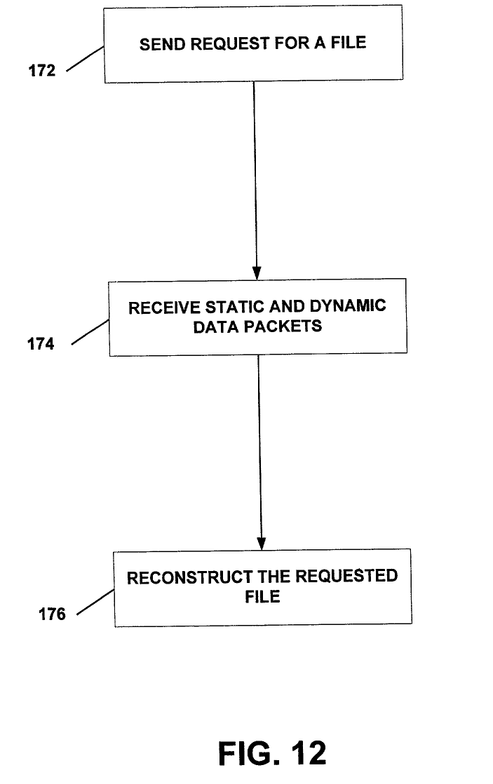

FIG. 12 is a flow diagram of the operation of one embodiment of the intelligent client. At block 172, the intelligent client 78 (FIG. 5) sends a request for a file to an intelligent server. The request may be partially satisfied at the ISP server as described above. The intelligent client receives the static and dynamic portions of the file at block 174. The client 78 recombines the static and dynamic data packets into the requested file.

In one embodiment, the static data may be broadcast to the intelligent client 78. The plug-in software 170 is capable of capturing and recombining the static data packets that are presented to it by the intelligent ISP server 82 (FIG. 5), based on a packet-multiplexing table.

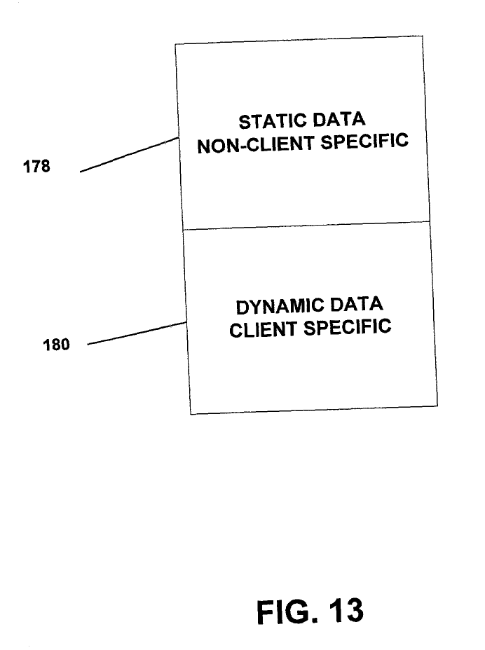

FIG. 13 illustrates the static and dynamic data content of a typical file. A typical requested file 88 (FIG. 5) such as the one illustrated here may be divided up into its dynamic data components 180 and its static data components 178. As described above, the static data may be defined based on its time dependency or its content and the rate of change of its content over time. This static data 178 is defined as non-client specific since its content does not vary based on the time the client places a request for that data. In contrast, the dynamic data 180 may have content that may change at a much higher rate than the static data and subsequently, at each time the client request is made, the data content may have changed. This data is classified as client specific data. The ratio of dynamic data to static data is dependent may vary based on the defined threshold used to divide dynamic and static data.

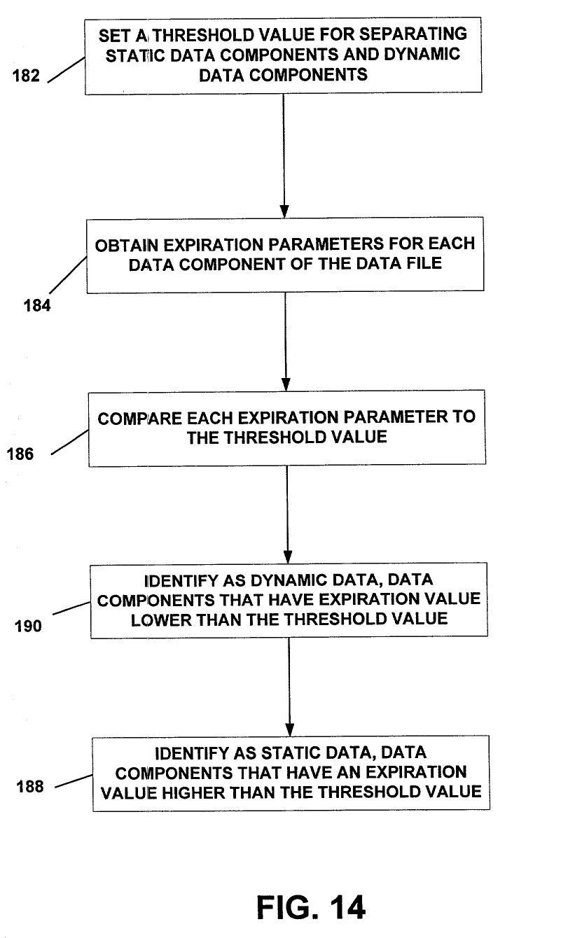

FIG. 14 is a flow diagram for the process of dividing a data file into its dynamic and static components for one embodiment of the present invention. At block 182, a threshold value is set for separating static data components and dynamic data components. The threshold value would be used to compare against an expiration parameter corresponding to each of part of a file. At block 184, the file server 86 may obtain the expiration parameters for each portion of the data in a particular file. At block 186, the file server 86 may compare the expiration parameter for each portion of the data file against the threshold value. At block 190, a dynamic data portion may be identified as the portion of the data file where the corresponding expiration parameter is less than the threshold value of the file server 86 (see FIG. 5). Alternatively, at block 188, if the expiration parameter of that portion of the data is measured to be higher than the threshold value, then that portion of the data may be identified as static data. In one embodiment, the operation of dividing a file into its dynamic and static components may be done offline, prior to receiving a request for that particular file.

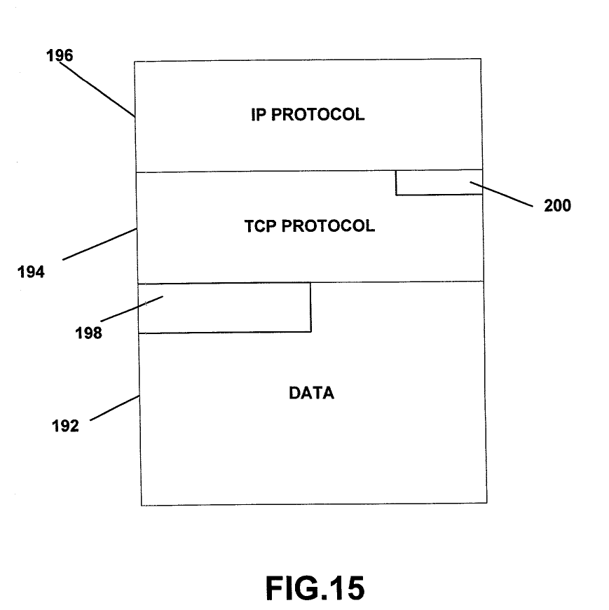

FIG. 15 illustrates a data packet 192 according to one embodiment of the present invention. In one embodiment, an identifying header 198 is added to the data packet 192 providing the information necessary for the operations of the network layer based on Internet Protocol (IP) 196 in identifying and transmitting the packet. Alternatively, the Transport layer protocol TCP 194 may include the addition of a header and/or trailer 200 to it prior to transmission. The new data packet may be distinguished from an old type data packet by inserting identifying information 200 in the (TCP) header 194. The additional bits of data added would be added to locations of the header 194 that is not currently used in the TCP protocol. This enables backward compatibility with existing technology and hardware. The new technology routers, ISP's and clients would be able to use the information inserted 198 or 200 in the TCP header 194 or in the data content 192 in order to recognize a new technology data packet from an old type data packet.

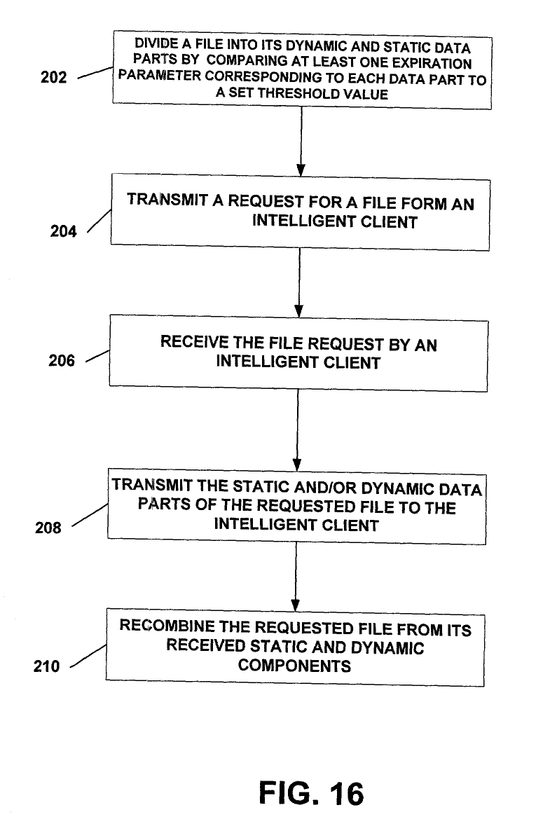

FIG. 16 is a flow diagram of the operation of a system based on one embodiment of the present invention. At block 202, a file is divided up into its dynamic and static data components by comparing at least one expiration parameter corresponding to each data part to a threshold value. The threshold value may be set at the file server based on an analysis of the current load of the server. In one embodiment of the present invention, threshold may be adjusted based on the changing file server traffic. A higher threshold would result in classifying a larger portion of a file as static data, which may result in a lower file server traffic.

At block 204, a file request is transmitted from an intelligent client to an intelligent server. At block 206, the intelligent file server receives the request from the intelligent client. At block 208, the intelligent file server transmits, multicasts or broadcasts the static data and/or dynamic data parts of the requested file to the requesting client. In one embodiment of the present invention, the intelligent file server may multicast the static data component after a having received a first request for that file. In another embodiment, the intelligent file server may start multicasting the static data components of the requested data as soon as it has received a number of requests for a particular file exceeding a specified number. At block 210, the intelligent client may receive the requested file and recreate the file by recombining it from its static and dynamic components.

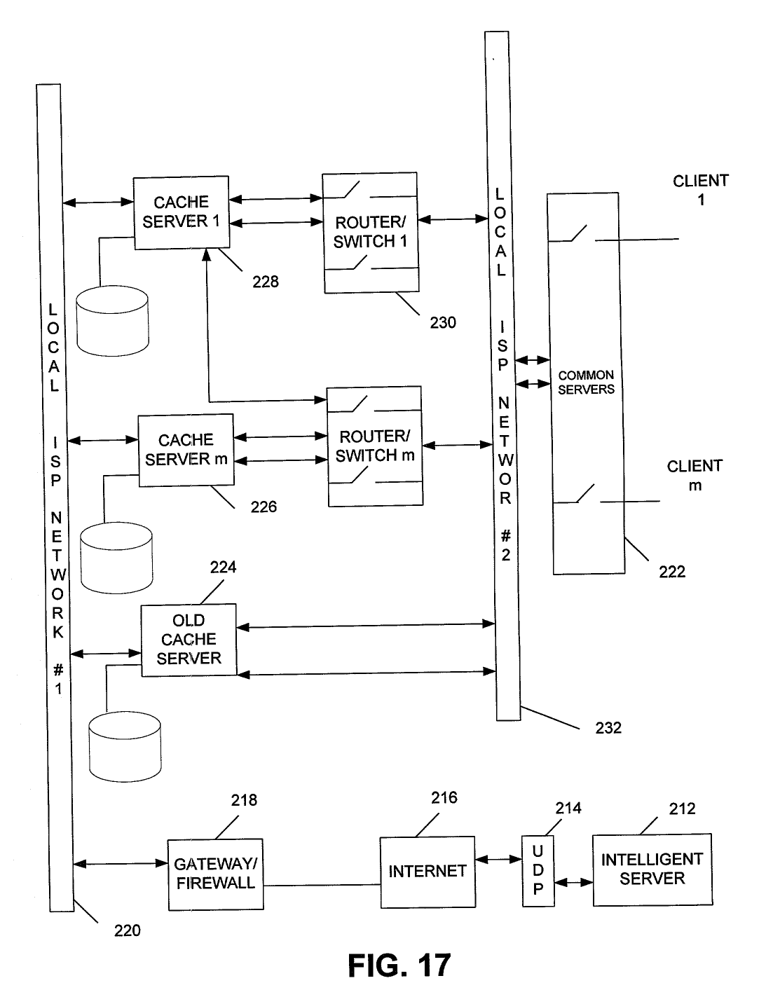

FIG. 17 depicts a simplified block diagram for one network embodiment of the present invention. An intelligent web server 212 is connected through a network connection such as the Internet 216 to the clients.

Data streams generated by the intelligent server 212 may have to pass through a firewall/gateway 218, protecting a local ISP network #1 220 that is servicing a group of intelligent clients 222 at specific URLs. The local ISP network #1 220 may include an old technology cache server 224 servicing non-intelligent clients that have not yet adopted a new intelligent browser, operating according to the teachings of the present invention. The local ISP network #1 220 may further include a series of intelligent cache servers 1.1-1.n through m.1-m.n (226-228). Each intelligent cache server, supports multiple URL addresses 1-m. Alternatively, multiple cache servers (1-m) 224-228 may service the same local ISP network 232.

Cache server 228 may provide services by multicasting requested static data to one set of URLs including clients at URL 1 through m (222). Each cache server, such as cache server#1 228, may multicast multiple streams of data 1.1 through 1.n, through routers 230 over a local ISP network #2, 232.

In one embodiment, once a first client sends a request for a given data having static data components residing on the cache server#1 228, the cache server starts its multicast of the static data. Furthermore, the cache server forwards the client generated request for the requested data to a web server and retrieves the dynamic data corresponding to the client requested data. Since this data is relatively more time sensitive than the static data, in one embodiment, the cache server#1 228 retrieves the dynamic data only upon receiving a client request.

In an example, after the receipt of the first client generated data request from an intelligent client 1 located at a given URL address, the corresponding router 230 acts to establish a connection between the client 1 and the cache server#1 228 storing the requested data. After a first request for a particular data file is received by the cache server#1 228, the cache server#1 228 may start a multicast of the static component of the data through the router 230 over a local ISP network #2 232 and is available to subsequent intelligent clients requesting the same data file. In one embodiment, the cache server#1 228 forwards a request for the dynamic component of the requested data file only after the receipt of a client data request. Furthermore, the cache server#1 228 multicasts data if it has the static component of the data in storage. Once the data is transmitted from the cache server#1 228, the router 230 transmits the multicast streams of static data over the local ISP network #2 232. Any subsequent client requesting the same data may obtain the data from the local ISP network #2 232.

In one embodiment, any request for a particular data file would trigger a request from the web server 212, for timely dynamic data, which is forwarded to each requesting client.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

We claim:

1. A method of parsing a data into its static and dynamic data components comprising:
setting a threshold value for separating static data components and dynamic data components;
obtaining expiration parameters for each data component of the data file;
comparing each expiration parameter to the threshold value;
identifying as dynamic data components the data components that have an expiration value lower than the threshold value; and
identifying as static data components the data components of the data that have an expiration value higher than the threshold value.

2. The method of claim 1 wherein the threshold value is set based on a measurement of a load value of a file server storing the data file.

3. The method of claim 1 wherein the threshold value of each file server can be independently set.

4. A method of sending data from an intelligent server comprising:
receiving a data request from a client;
determining whether the client is intelligent;
parsing the data into static and dynamic components, wherein the static and dynamic components are separated based on a selected threshold value; and
transmitting the static components and the dynamic components of the data to an intelligent client.

5. The method of claim 4 wherein the intelligent server parses the requested data into its static and dynamic components after a request is received.

6. The method of claim 4 wherein the intelligent server parses the requested data into its static and dynamic components before any request is received.60630-3001010630-300101

7. The method of claim 4 wherein the intelligent file server multicasts the static components of the requested data, and forwards the dynamic components of the requested data.

8. The method of claim 4 wherein the intelligent file server broadcasts the static components of the requested data, and forwards the dynamic components of the requested data.

9. The method of claim 4 wherein the intelligent file server forwards the static components and the dynamic components of the requested data.

10. The method of claim 4 further comprising:
counting the number of requests from intelligent clients for a particular data file;
broadcasting the static data components of said data file to each intelligent client once a number of requests for a particular file surpasses a set value.

11. The method of claim 10 wherein the static data components broadcasting further comprising:
(a) receiving a data file including static data components and dynamic data components;
(b) specifying a time interval;
(c) parsing the static data components into a plurality of static data blocks;
(d) determining a required number of time slots to send the data file, wherein each of said time slot has a duration substantially equal to said time interval;
(e) allocating to each time slot at least;
(1) a first of said plurality of data blocks; and
(2) optionally one or more additional data blocks, such that said plurality of data blocks is available to a client accessing said data file during any time slot; and
(f) sending said plurality of data blocks based on said allocating step (e).

12. A method for processing data received from an intelligent server comprising:
sending a data request from an intelligent client to the intelligent server, wherein the intelligent server stores the static components and the dynamic components of the requested data, and wherein the intelligent server packetizes and transmits the static and dynamic components of the requested data upon;
receiving static data packets and dynamic data packets;
reconstructing the requested data from the received static data packets and dynamic data packets.

13. The method of claim 12 including the step of receiving static data from a broadcast, further comprising:
(a) receiving a selection of a data file during a first time slot;
(b) receiving at least one data block of said data file during a second time slot; and
(c) during a next time slot:
(1) receiving any data block not already received;
(2) recombining the received data blocks to form the data file; and
(3) repeating step (c) until all data blocks of said data file have been received and recombined.

14. The method of claim 13 wherein further comprising:
performing an error check; and
sending a request to resend the data blocks generating the error check.

15. The method of claim 13 wherein the step of recombining of the data blocks does not start until after all the data files have been received.

16. The method of claim 12 further including the steps of receiving the static data packets from a multicast.

17. A method of creating a data packet based on an intelligent protocol comprising:
including identifying information used for identifying the intelligent data protocol.

18. The method of claim 17 wherein said identification information is included in a header portion of the data packet.

19. The method of claim 18 wherein the data packet is created based on TCP/IP protocol.

20. The method of claim 19 wherein the header portion is the TCP information portion.

21. The method of claim 17 wherein said identification information is included in the data portion of the data packet.

22. The method of claim 21 wherein the data packet is created based on TCP/IP protocol.

23. A method of processing a data request from an intelligent client connected to a network through a network service provider server, said method comprising:
receiving a request for data from the intelligent client;
querying a cache server for static components of the requested data;
performing one of:
sending a request for static components and dynamic components of the data requested to an intelligent web server, if the static components of the requested data is not stored in the cache server and storing a copy of the static components of the requested data after it has been received, and
sending a request for the dynamic components of the data requested to an intelligent web server, if the static components of the requested data is stored in the cache server;
forwarding the dynamic components of the requested data received from the intelligent server to the intelligent client; and
multicasting the static components of the requested and received data.

24. A method of responding to a data request from a client by an intelligent network connection providing server comprising:
receiving a file request from a client;
determining whether the client is intelligent;
sending a static components of the requested data to the client;
forwarding a request for at least a dynamic components of the requested data;
receiving at least the dynamic components of the requested data; and
transmitting at least the dynamic data to the client.

25. The method of claim 24 wherein the data request is from a non-intelligent client.

26. The method of claim 25 further comprising:
passing the data request to a non-intelligent server.

27. The method of claim 24 wherein multicasting of the static components is further comprising:
(a) specifying a time interval;
(b) parsing the static components into a plurality of static data blocks;
(c) determining a required number of time slots to send the static components, wherein each of said time slot has a duration substantially equal to said time interval;
(d) allocating to each time slot at least;
(1) a first of the plurality of static data blocks; and
(2) optionally one or more additional static data blocks; and
(e) sending the plurality of static data blocks based on said allocating step (d).

28. A method of operation for a system for transmitting and receiving data within a network comprising:
dividing a file into dynamic data and static data by comparing at least one expiration parameter corresponding to each data part to a set threshold value;
transmitting a request for a file from an intelligent client;
receiving the file request by an intelligent server;
transmitting at least the dynamic data components of the requested file to the intelligent client;, and
recombining the static components and the dynamic components of the requested file.

29. The method of claim 28 wherein the transmission of the static data components is by multicasting.

30. The method of claim 29 wherein the static data broadcasting steps further comprises:
(a) receiving a static data blocks of a data file;
(b) specifying a time interval;
(c) parsing said data file into a plurality of data blocks based on said time interval such that each data block is displayable during said time interval;
(d) determining a required number of time slots to send said data file, wherein each of said time slot has a duration substantially equal to said time interval;
(e) allocating to each time slot at least;
(1) a first of said plurality of data blocks; and
(2) optionally one or more additional data blocks, such that said plurality of data blocks is available in sequential order to a client accessing said data file during any time slot; and
(f) sending said plurality of data blocks based on said allocating step (e).

31. The method of claim 28 wherein parsing of the requested file into its static and dynamic data components is performed in real time.

32. The method of claim 28 wherein parsing of the requested file into its static and dynamic data components is performed in before the receipt of any data request.

33. A method of sending a file over a network from an originating node to a requesting client, comprising:
receiving a request for the file at an intermediate node;
providing a time insensitive component of the file to the client from the intermediate node; and
providing a time sensitive component of the file to the client from the originating node.

34. The method of claim 33 further comprising:
determining whether or not components of a file are time sensitive or time insensitive based on a comparison between a threshold value and a defined time value for each of the components.

35. The method of claim 34 wherein the threshold value is dependent on the load of the originating server.

36. The method of claim 33 further comprising the steps of:
determining at the intermediate node whether or not the client is adapted to receive time insensitive and time sensitive components; and if the client is not so adapted,
passing the request for the file to a non-intelligent server.

37. A computer program product embodied in a computer readable medium for parsing a data into its static and dynamic data components comprising:
code means for setting a threshold value for separating static data components and dynamic data components;
code means for obtaining expiration parameters for each data component of the data file;
code means for comparing each expiration parameter to the threshold value;
code means for identifying as dynamic data components the data components of the data that have an expiration value lower than the threshold value; and
code means for identifying as static data components the data components of the data that have an expiration value higher than the threshold value.

38. The computer program product of claim 37 wherein the threshold value is set based on a measurement of a load value of a file server storing the data file.

39. The computer program product of claim 37 wherein the threshold value of each file server can be independently set.

40. A computer program product embodied in a computer readable medium for sending data from an intelligent server comprising:
receiving a data request from a client;
determining whether the client is intelligent;
parsing the data into static and dynamic components, wherein the static and dynamic components are separated based on a selected threshold value; and
transmitting the static components and the dynamic components of the data to an intelligent client.

41. The computer program product of claim 40 wherein the intelligent server parses the requested data into its static and dynamic components after a request is received.

42. The computer program product of claim 40 wherein the intelligent server parses the requested data into its static and dynamic components before any request is received.

43. The computer program product of claim 40 wherein the intelligent file server multicasts the static components of the requested data, and forwards the dynamic components of the requested data.

44. The computer program product of claim 40 wherein the intelligent file server broadcasts the static components of the requested data, and forwards the dynamic components of the requested data.

45. The computer program product of claim 40 wherein the intelligent file server forwards the static components and the dynamic components of the requested data.

46. The computer program product of claim 40 further comprising:
counting the number of requests from intelligent clients for a particular data file;
broadcasting the static data components of said data file to each intelligent client once a number of requests for a particular file surpasses a set value.

47. The computer program product of claim 46 wherein the static data components broadcasting further comprising:
(a) receiving a data file including static data components and dynamic data components;
(b) specifying a time interval;
(c) parsing the static data components into a plurality of static data blocks;
(d) determining a required number of time slots to send the data file, wherein each of said time slot has a duration substantially equal to said time interval;
(e) allocating to each time slot at least;
(1) a first of said plurality of data blocks; and
(2) optionally one or more additional data blocks, such that said plurality of data blocks is available to a client accessing said data file during any time slot; and
(f) sending said plurality of data blocks based on said allocating step (e).

48. A computer program product embodied in a computer readable medium for processing data received from an intelligent server comprising:
sending a data request from an intelligent client to the intelligent server, wherein the intelligent server stores the static components and the dynamic components of the requested data, and wherein the intelligent server packetizes and transmits the static and dynamic components of the requested data upon;
receiving static data packets and dynamic data packets;
reconstructing the requested data from the received static data packets and dynamic data packets.

49. The computer program product of claim 48 including the step of receiving static data from a broadcast, further comprising:
(a) receiving a selection of a data file during a first time slot;
(b) receiving at least one data block of said data file during a second time slot; and
(c) during a next time slot:
(1) receiving any data block not already received;
(2) recombining the received data blocks to form the data file; and
(3) repeating step (c) until all data blocks of said data file have been received and recombined.

50 The computer program product of claim 49 wherein further comprising:
performing an error check; and
sending a request to resend the data blocks generating the error check.

51. The computer program product of claim 49 wherein the step of recombining of the data blocks does not start until after all the data files have been received.

52. The computer program product of claim 48 further including the steps of receiving the static data packets from a multicast.

53. A computer program product embodied in a computer readable medium for creating a data packet based on an intelligent protocol comprising:
including identifying information used for identifying the intelligent data protocol.

54. The computer program product of claim 49 wherein said identification information is included in a header portion of the data packet.

55. The computer program product of claim 54 wherein the data packet is created based on TCP/IP protocol.

56. The computer program product of claim 55 wherein the header portion is the TCP information portion.

57. The computer program product of claim 53 wherein said identification information is included in the data portion of the data packet.

58. The computer program product of claim 57 wherein the data packet is created based on TCP/IP protocol.

59. A computer program product embodied in a computer readable medium for processing a data request from an intelligent client connected to a network through a network service provider server, said computer program product comprising:
receiving a request for data from the intelligent client;
querying a cache server for static components of the requested data;
performing one of:
sending a request for static components and dynamic components of the data requested to an intelligent web server, if the static components of the requested data is not stored in the cache server and storing a copy of the static components of the requested data after it has been received, and
sending a request for the dynamic components of the data requested to an intelligent web server, if the static components of the requested data is stored in the cache server;
forwarding the dynamic components of the requested data received from the intelligent server to the intelligent client; and
multicasting the static components of the requested and received data.

60. A computer program product embodied in a computer readable medium for responding to a data request from a client by an intelligent network connection providing server comprising:
receiving a file request from a client;
determining whether the client is intelligent;
sending a static components of the requested data to the client;
forwarding a request for at least a dynamic components of the requested data;
receiving at least the dynamic components of the requested data; and
transmitting at least the dynamic data to the client.

61. The computer program product of claim 60 wherein the data request is from a non-intelligent client.

62. The computer program product of claim 61 further comprising:
passing the data request to a non-intelligent server.

63. The computer program product of claim 60 wherein multicasting of the static components is further comprising:
(a) specifying a time interval;
(b) parsing the static components into a plurality of static data blocks;
(c) determining a required number of time slots to send the static components, wherein each of said time slot has a duration substantially equal to said time interval;
(d) allocating to each time slot at least;
(1) a first of the plurality of static data blocks; and
(2) optionally one or more additional static data blocks; and
(e) sending the plurality of static data blocks based on said allocating step (d).

64. A computer program product embodied in a computer readable medium for transmitting and receiving data within a network comprising:
dividing a file into dynamic data and static data by comparing at least one expiration parameter corresponding to each data part to a set threshold value;
transmitting a request for a file from an intelligent client;
receiving the file request by an intelligent server;
transmitting at least the dynamic data components of the requested file to the intelligent client; and
recombining the static components and the dynamic components of the requested file.

65. The computer program product of claim 64 wherein the transmission of the static data components is by multicasting.

66. The computer program product of claim 65 wherein the static data broadcasting steps further comprises:
(a) receiving a static data blocks of a data file;
(b) specifying a time interval;
(c) parsing said data file into a plurality of data blocks based on said time interval such that each data block is displayable during said time interval;
(d) determining a required number of time slots to send said data file, wherein each of said time slot has a duration substantially equal to said time interval;
(e) allocating to each time slot at least;
(1) a first of said plurality of data blocks; and
(2) optionally one or more additional data blocks, such that said plurality of data blocks is available in sequential order to a client accessing said data file during any time slot; and
(f) sending said plurality of data blocks based on said allocating step (e).

67. The computer program product of claim 64 wherein parsing of the requested file into its static and dynamic data components is performed in real time.

68. The computer program product of claim 64 wherein parsing of the requested file into its static and dynamic data components is performed in before the receipt of any data request.

69. A computer program product embodied in a computer readable medium for sending a file over a network from an originating node to a requesting client, comprising:
receiving a request for the file at an intermediate node;
providing a time insensitive component of the file to the client from the intermediate node; and
providing a time sensitive component of the file to the client from the originating node.

70. The computer program product of claim 69 further comprising:
determining whether or not components of a file are time sensitive or time insensitive based on a comparison between a threshold value and a defined time value for each of the components.

71. The computer program product of claim 70 wherein the threshold value is dependent on the load of the originating server.

72. An apparatus for parsing a data into its static and dynamic data components comprising:
means for setting a threshold value for separating static data components and dynamic data components;
means for obtaining expiration parameters for each data component of the data file;
means for comparing each expiration parameter to the threshold value;
means for identifying as dynamic data components the data components of the data that have an expiration value lower than the threshold value; and
means for identifying as static data components the data components of the data that have an expiration value higher than the threshold value.

73. The apparatus of claim 72 wherein the threshold value is set based on a measurement of a load value of a file server storing the data file.

74. The apparatus of claim 72 wherein the threshold value of each file server can be independently set.

75. An apparatus for sending data from an intelligent server comprising:
means for receiving a data request from a client;
means for determining whether the client is intelligent;
means for parsing the data into static and dynamic components, wherein the static and dynamic components are separated based on a selected threshold value; and
means for transmitting the static components and the dynamic components of the data to an intelligent client.

76. The apparatus of claim 75 wherein the intelligent server parses the requested data into its static and dynamic components after a request is received.

77. The apparatus of claim 75 wherein the intelligent server parses the requested data into its static and dynamic components before any request is received.

78. The apparatus of claim 75 wherein the intelligent file server multicasts the static components of the requested data, and forwards the dynamic components of the requested data.

79. The apparatus of claim 75 wherein the intelligent file server broadcasts the static components of the requested data, and forwards the dynamic components of the requested data.

80. The apparatus of claim 75 wherein the intelligent file server forwards the static components and the dynamic components of the requested data.

81. The apparatus of claim 75 further comprising:
means for counting the number of requests from intelligent clients for a particular data file;
means for broadcasting the static data components of said data file to each intelligent client once a number of requests for a particular file surpasses a set value.

82. The apparatus of claim 81 wherein the static data components broadcasting further comprising:
(a) means for receiving a data file including static data components and dynamic data components;
(b) means for specifying a time interval;
(c) means for parsing the static data components into a plurality of static data blocks;
(d) means for determining a required number of time slots to send the data file, wherein each of said time slot has a duration substantially equal to said time interval;
(e) means for allocating to each time slot at least;
(1) a first of said plurality of data blocks; and
(2) optionally one or more additional data blocks, such that said plurality of data blocks is available to a client accessing said data file during any time slot; and
(f) means for sending said plurality of data blocks based on said allocating step (e).

83. An apparatus for processing data received from an intelligent server comprising:
means for sending a data request from an intelligent client to the intelligent server, wherein the intelligent server stores the static components and the dynamic components of the requested data, and wherein the intelligent server packetizes and transmits the static and dynamic components of the requested data upon;
means for receiving static data packets and dynamic data packets;
means for reconstructing the requested data from the received static data packets and dynamic data packets.

84. The apparatus of claim 83 including the step of receiving static data from a broadcast, further comprising:
(a) means for receiving a selection of a data file during a first time slot;
(b) means for receiving at least one data block of said data file during a second time slot; and
(c) means for during a next time slot:
(1) means for receiving any data block not already received;
(2) means for recombining the received data blocks to form the data file; and
(3) means for repeating step (c) until all data blocks of said data file have been received and recombined.

85. The apparatus of claim 84 wherein further comprising:
means for performing an error check; and
means for sending a request to resend the data blocks generating the error check.

86. The apparatus of claim 84 wherein the step of recombining of the data blocks does not start until after all the data files have been received.

87. The apparatus of claim 86 further including the steps of receiving the static data packets from a multicast.

88. An apparatus for creating a data packet based on an intelligent protocol comprising:
means for including identifying information used for identifying the intelligent data protocol.

89. The apparatus of claim 88 wherein said identification information is included in a header portion of the data packet.

90. The apparatus of claim 89 wherein the data packet is created based on TCP/IP protocol.

91. The apparatus of claim 90 wherein the header portion is the TCP information portion.

92. The apparatus of claim 88 wherein said identification information is included in the data portion of the data packet.

93. The apparatus of claim 92 wherein the data packet is created based on TCP/IP protocol.

94. An apparatus for processing a data request from an intelligent client connected to a network through a network service provider server, said method comprising:
means for receiving a request for data from the intelligent client;
means for querying a cache server for static components of the requested data;
means for performing one of:
means for sending a request for static components and dynamic components of the data requested to an intelligent web server, if the static components of the requested data is not stored in the cache server and storing a copy of the static components of the requested data after it has been received, and
means for sending a request for the dynamic components of the data requested to an intelligent web server, if the static components of the requested data is stored in the cache server;
means for forwarding the dynamic components of the requested data received from the intelligent server to the intelligent client; and
means for multicasting the static components of the requested and received data.

95. An apparatus for responding to a data request from a client by an intelligent network connection providing server comprising:
means for receiving a file request from a client;
means for determining whether the client is intelligent;
means for sending a static components of the requested data to the client;
forwarding a request for at least a dynamic components of the requested data;
means for receiving at least the dynamic components of the requested data; and
means for transmitting at least the dynamic data to the client.

96. The apparatus of claim 95 wherein the data request is from a non-intelligent client.

97. The apparatus of claim 96 further comprising:
means for passing the data request to a non-intelligent server.

98. The apparatus of claim 95 wherein multicasting of the static components is further comprising:
(a) means for specifying a time interval;
(b) means for parsing the static components into a plurality of static data blocks;
(c) means for determining a required number of time slots to send the static components, wherein each of said time slot has a duration substantially equal to said time interval;
(d) means for allocating to each time slot at least;
(1) a first of the plurality of static data blocks; and
(2) optionally one or more additional static data blocks; and
(e) means for sending the plurality of static data blocks based on said allocating step (d).

99. An apparatus for operation for a system for transmitting and receiving data within a network comprising:
means for dividing a file into dynamic data and static data by comparing at least one expiration parameter corresponding to each data part to a set threshold value;
means for transmitting a request for a file from an intelligent client;
means for receiving the file request by an intelligent server;
means for transmitting at least the dynamic data components of the requested file to the intelligent client; and
means for recombining the static components and the dynamic components of the requested file.

100. The apparatus of claim 99 wherein the transmission of the static data components is by multicasting.

101. The apparatus of claim 100 wherein the static data broadcasting steps further comprises:
(a) means for receiving a static data blocks of a data file;
(b) means for specifying a time interval;
(c) means for parsing said data file into a plurality of data blocks based on said time interval such that each data block is displayable during said time interval;
(d) means for determining a required number of time slots to send said data file, wherein each of said time slot has a duration substantially equal to said time interval;
(e) means for allocating to each time slot at least;
(1) a first of said plurality of data blocks; and
(2) optionally one or more additional data blocks, such that said plurality of data blocks is available in sequential order to a client accessing said data file during any time slot; and
(f) means for sending said plurality of data blocks based on said allocating step (e).

102. The apparatus of claim 99 wherein parsing of the requested file into its static and dynamic data components is performed in real time.

103. The apparatus of claim 99 wherein parsing of the requested file into its static and dynamic data components is performed in before the receipt of any data request.

104. An apparatus for sending a file over a network from an originating node to a requesting client, comprising:
means for receiving a request for the file at an intermediate node;
means for providing a time insensitive component of the file to the client from the intermediate node; and
means for providing a time sensitive component of the file to the client from the originating node.

105 The apparatus of claim 104 further comprising:
means for determining whether or not components of a file are time sensitive or time insensitive based on a comparison between a threshold value and a defined time value for each of the components.

106. The apparatus of claim 105 wherein the threshold value is dependent on the load of the originating server.

107. The apparatus of claim 104 further comprising the steps of:
means for determining at the intermediate node whether or not the client is adapted to receive time insensitive and time sensitive components; and if the client is not so adapted,
means for passing the request for the file to a non-intelligent server.
